(19) United States
(12) Patent Application Publication
(10) Pub. No.: US 2005/0005470 A1
(43) Pub. Date: Jan. 13, 2005

(54) Power tool with integrated tape measure

(76) Inventor: Gregory S. Snider, Bel Air, MD (US)

Correspondence Address: HARNESS, DICKEY & PIERCE, P.L.C., P.O. BOX 828, BLOOMFIELD HILLS, MI, 48303, US

(21) Appl. No.: 10/616,349

(22) Filed: Jul. 9, 2003

(51) Int. Cl. G01B 3/10

(52) U.S. Cl. 33/760

(57) ABSTRACT

A power tool has a housing with a motor and power source coupled within the housing. An output is coupled with the motor and is adapted to be coupled with a tool. An activation member is electrically coupled with the motor and the power source to drive the output. A measuring device is positioned in the housing. The measuring device may be used while positioned in the housing. The measuring device may also be removed from the housing and used outside of it.

### FIELD OF THE INVENTION

The present invention relates to power tools, and more particularly, to power tools which include an integrated on-board tape measure.

### BACKGROUND OF THE INVENTION

Workmen who utilize power tools usually require a measuring device so that the workmen knows where to position one item with respect to another on a workpiece. Also, the workmen may need to make various cuts or remove parts from the workpiece. This necessitates measuring the workpiece in order to achieve the desired alterations in the Workpiece. In the past, workmen have utilized tape measures that have attached to a belt, utility bag, or has been placed in his pocket. Thus, workmen are always scrambling to find their measuring devices.

German Application 201 02 674 illustrates a drill having an auxiliary handle. The auxiliary handle includes a magazine for additional accessories, The handle is removable from the auxiliary magazine. The magazine may include a tape measure or tape rule. While it appears that this application works satisfactorily for its intended purpose, designers strive to improve the art.

The present invention provides the art with a power tool with an integrated measuring device on the tool housing. The measuring device includes a self-marking element. The measuring device is usable while onboard the tool housing. Also, the measuring device is removable to be utilized as a measuring device.

### SUMMARY OF THE INVENTION

A power tool in accordance with the present invention comprises a housing. A motor is positioned within the housing. A power source is coupled with the motor. The power source has a portion positioned in the housing. An output is coupled with the motor and is adapted to be coupled with a tool. The output has a portion positioned inside of the housing. An activation member is positioned on the housing and is coupled with the motor to activate and deactivate the motor which, in turn, drives or idles the output. A measuring device is positioned in the housing adjacent the motor. The measuring device is usable while it is in the housing. Also, the measuring device is removable from the housing to be used outside of the housing. The measuring device is a tape measure having an end member which is capable of marking a workpiece. Also, the housing includes an aperture to receive the measuring device.

In accordance with another aspect of the invention, a power tool comprises a housing having two ends. One end accommodates an output and the other end accommodates a power source. A motor is positioned in the housing between the ends. The power source is positioned adjacent one end of the housing. An output is coupled with the motor and is adapted to be coupled with a tool. The output is accommodated with one end of the housing. An activation member is positioned on the housing and is coupled with the motor to activate and deactivate the motor which, in turn, drives or idles the output. A measuring device is positioned adjacent the power source end of the housing. The measuring device is usable when it is coupled with the housing. Also, the measuring device is usable when it is removed from the housing. The power source is a battery positioned within the housing.

In accordance with a third aspect of the present invention, a power tool comprises a housing with a desired configuration defining a shape of the power tool. The housing has a hand manipulation portion on the housing and a motor receiving portion and a power source receiving portion. A motor and power source are received in their respective portions in the housing. An output is coupled with the motor and is adapted to be coupled with a tool. The output is accommodated in the housing adjacent to the motor portion. An activation member is positioned on the housing and is coupled with the motor to activate and deactivate the motor which, in turn, drives or idles the output. A measuring device is positioned in the housing adjacent the motor and the power source housing portion such that the measuring device is prohibited from interfering with operation of the motor and/or power source. The measuring device is operable while it is on the housing. Also, the measuring device may be removed from the housing for operations outside of the housing.

From the following detailed description taken in conjunction with the accompanying drawings and claims, other objects and advantages will become apparent to those skilled in art.

### BRIEF DESCRIPTION OF THE DRAWINGS

The foregoing and other features of the present invention will become apparent to one skilled in the art to which the present invention relates upon consideration of the invention with reference to the accompanying drawings, wherein:

FIG. 1 is a perspective view of a power tool, specifically a screwdriver, in accordance with the present invention.

FIG. 2 is an enlarged perspective view of the tape extending from the tool.

FIG. 3 is an enlarged perspective view of the measuring device removed from the tool with the tool rotated 180°.

FIG. 4 is a cross-sectional view along line 4-4 of FIG. 3 with the tape measuring device removed.

FIGS. 5A and 5B are cross-section in view along line 5-5 of FIG. 4.

FIG. 6 is a perspective view of the present invention on a drill.

FIG. 7 of the present invention on a jigsaw.

FIG. 8 is a perspective view of the present invention on a circular saw.

### DETAILED DESCRIPTION OF THE PREFERRED EMBODIMENTS

Turning to the figures, a power tool is illustrated and designated with the reference numeral 10. The power tool 10 is illustrated as a pivotal screwdriver. The power tool 10 includes a housing 12 having a first portion 14 to receive a motor 16 and a second portion 18 to receive a power source or battery 20. While a battery is shown, the power tool could be an AC device and include a cord. Also, the housing 12 includes a handle manipulating portion 22 where the tool is to be held by a user.

The tool 10 includes an activating member 24 which is electrically coupled with the power source 20 and the motor 16. Also, the power tool includes an output 26 which includes a device 28, such as a shank or chuck, to couple with a tool. The output 26 is rotatably connected to a pinion of the motor so that as the activation member 24 is moved, the motor in turn is energized which rotates the output spindle 26. When pressure is removed from the activating member 24, the motor will be de-energized and accordingly, the output will cease to rotate. The activation member 24 has two on positions to energize the reversible motor so that the output rotates clockwise and counterclockwise. Also, the housing includes a pivot 30 which enables the motor section 14 to pivot with respect to the power source section 18.

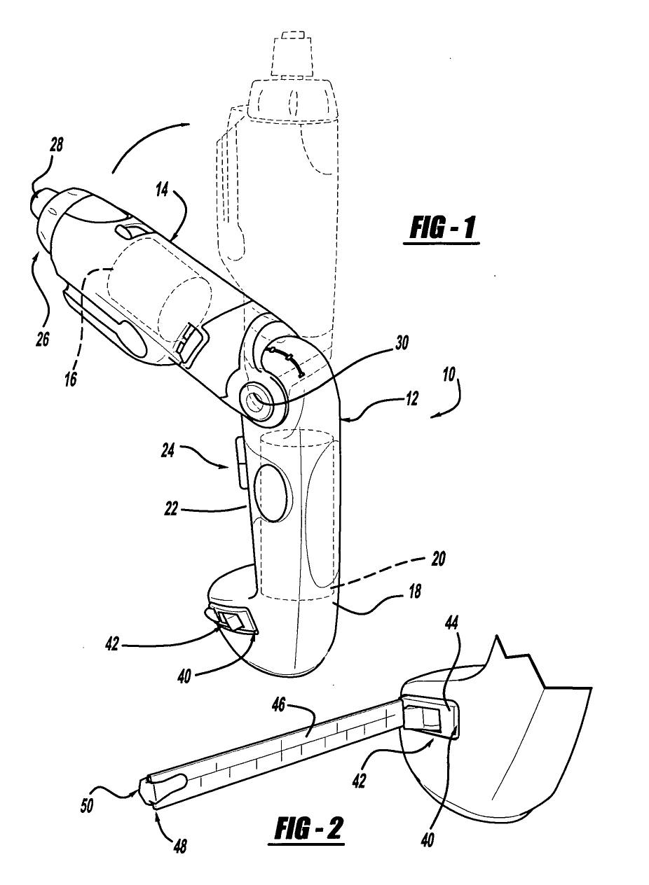

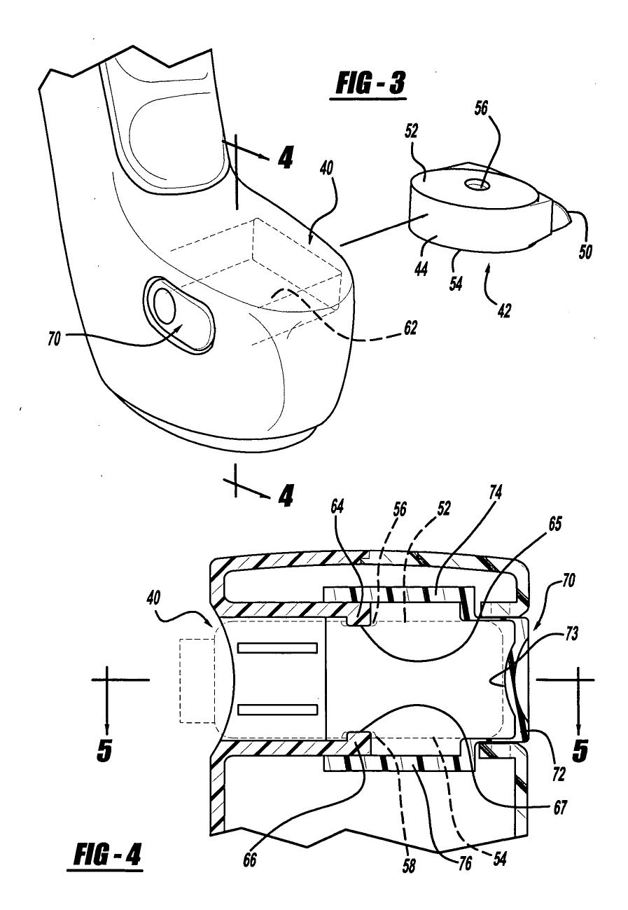

The housing 12 includes a receiving chamber 40 to receive a measuring device 42. The measuring device 42 is of the tape measuring type. FIGS. 2 through 5 provide a better understanding of the tape measuring device and the tape measuring receiving chamber.

The tape measure 42 includes a housing 44 and a tape 46. The tape 46 has an end member 48. The end member 48 has a pointed tab 50 which enables the tab 50 to mark the workpiece. Thus, the end member 48 is a self-marking implement.

The housing 44 includes a pair of sidewalls 52 and 54. The sidewalls 52 and 54 include dimples 56 and 58. The dimples 56 and 58 receive biasing fingers which retain the measuring device 42 in the housing chamber. The measuring device 42 can be used while it is secured in the power tool housing 12. Also, the measuring device 42 may be removed from the chamber and used in a conventional manner. The self-marking feature eliminates marking instruments such as pencils, pens or the like, which enhances the workman's efficiency.

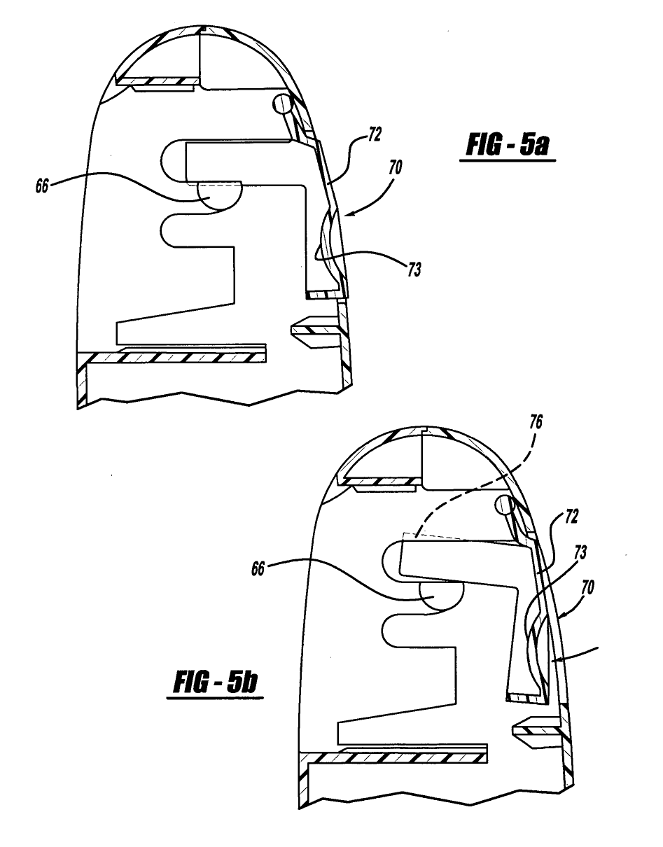

The measuring device receiving chamber 40 is formed in the side of the housing. The chamber has an overall rectangular opening 62 to receive the measuring device 42. The chamber 60 includes a pair of opposing biasing fingers 64 and 66. The biasing fingers 64 and 66 project outwardly from the housing chamber walls. The biasing fingers 64 and 66 fit into dimples 56 and 58, as illustrated in FIG. 4, to retain the measuring device 42 in the housing 12. The tape housing 44 is flush with the tool housing 12, however, the tape end 48 is accessible. If the tape end 48 is pulled, it will slide out of the housing 44 as seen in FIG. 2. Thus, the measuring device 42 is locked into the housing 12 when the fingers 64 and 66 are engaged in the dimples 56. 58 enabling the tape measure to be used while it is locked on the tool.

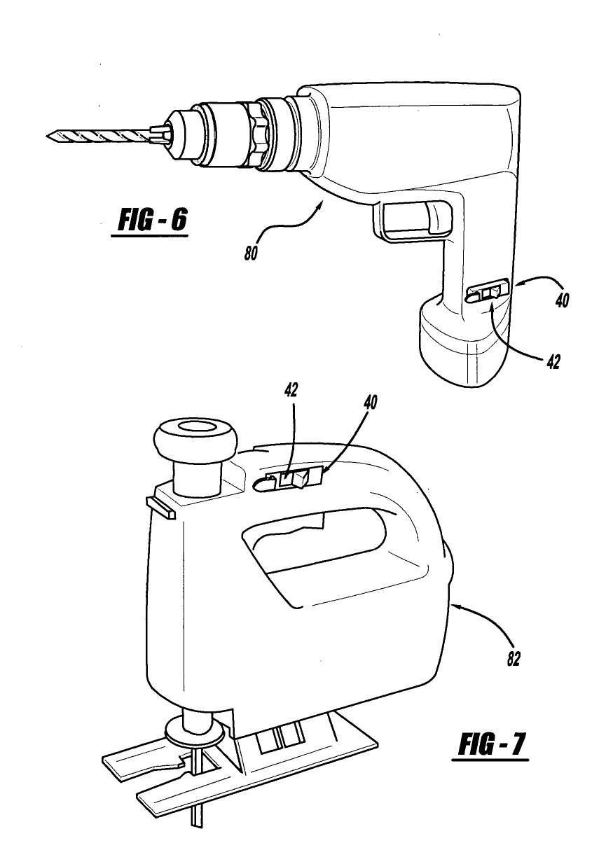

In order to remove the measuring device 42 from the housing 12 push button 70 is activated. Push button 70 includes a body 72 with extending arms 74 and 76. When the measuring device is locked (FIG. 5a) in the chamber 40, arms 74 and 76 are positioned behind arms 64 and 66 reinforcing the retention of tabs 65 and 67 into dimples 56 and 58. When push button 70 is activated (FIG. 5b), the body 72, at one end, pivots which, in turn, rotates arms 74 and 76 out from behind arms 64 and 66 while a tab 73 on body 72 contacts the measuring device 42 forcing the measuring device 42 out of the chamber 40. Thus, the measuring device 42 extends from the chamber 60, while still being held at fingers 64 and 66, enabling the user to remove the measuring device 42 from the housing 12.

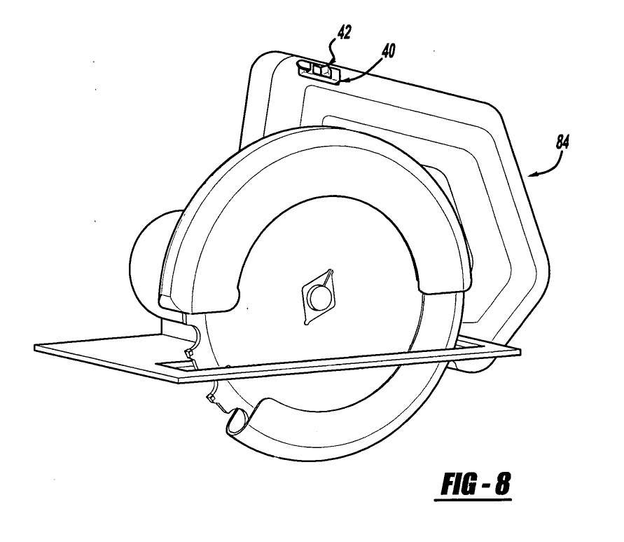

Turning to FIGS. 6 through 8, the measuring device is illustrated on various power tool devices. In FIG. 6, the measuring device 42 having a receiving chamber 60 like those described are illustrated on a drill 80. Turning to FIG. 7, the chamber 40 with the measuring device 42 is illustrated on a jigsaw 82. Turning to FIG. 8, the chamber 40 is illustrated with the measuring device 42 on a circular saw 84.

While the above describes the preferred embodiment of the present invention, those skilled in the art will appreciate that modifications, alterations and changes can be made to the present device without deviating from the scope and spirit of the present invention.

1. A power tool comprising:
a housing:
a motor positioned within said housing;
a power source coupled with said motor having a portion positioned in said housing for operating said motor;
an output coupled with said motor and adapted to be coupled with a tool, said output having a portion positioned inside said housing;
an activation member positioned on said housing and coupled with said motor for activating and deactivating said motor which, in turn, drives said output; and
a measuring device positioned in said housing and said measuring device being usable while in said housing and being removable for use outside of said housing.

2. The power tool of claim 1, wherein said measuring device is a tape measure.

3. The power tool of claim 2, comprising an end member on said tape measure, said end member enables marking of a workpiece.

4. The power tool of claim 1, wherein said housing includes a chamber for receiving said measuring device.

5. A power tool comprising:
a housing, said housing having two ends, one end accommodating an output and the other end accommodating a power source
a motor positioned within said housing;
a power source coupled with said motor having a portion positioned in said housing for operating said motor;
an output coupled with said motor and adapted to be coupled with a tool, said output having a portion positioned inside said housing;
an activation member positioned on said housing and coupled with said motor for activating and deactivating said motor which, in turn, drives and idles said output; and
a measuring device positioned adjacent said power source end of said housing, said measuring device usable when coupled with said housing and when removed from said housing.

6. The power tool of claim 5 wherein said measuring device is a tape measure.

7. The power tool of claim 6, comprising an end member on said tape measure enables marking of a workpiece.

8. The power tool of claim 5, wherein said housing includes a chamber for receiving said measuring device.

9. The power tool of claim 5, wherein the power source is a battery positioned in said power tool.

10. A power tool comprising:
a housing, said housing having a desired configuration defining a shape of the power tool, said housing having a hand manipulation portion on said housing and said housing having a motor receiving portion and a power source receiving portion;
a motor positioned within said housing;
a power source coupled with said motor having a portion positioned in said housing for operating said motor;
an output coupled with said motor and adapted to be coupled with a tool, said output having a portion positioned inside said housing;
an activation member positioned on said housing and coupled with said motor for activating and deactivating said motor which, in turn, drives and idles said output; and
a measuring device positioned in said housing such that said measuring device is prohibited from interference with operation of said motor and/or power source, and said measuring device operable while in said housing and said measuring device removable from said housing for operation outside of said housing.

11. The power tool of claim 10, wherein said measuring device is a tape measure.

12. The power tool of claim 11, comprising an end member on said tape measure enables marking of a workpiece.

13. The power tool of claim 10, wherein said housing includes a chamber for receiving said measuring device.

14. The power tool of claim 10, wherein the power source is a battery positioned in said power tool.

15. The power tool of claim 1, wherein a measuring device ejector is coupled with said housing.

16. The power tool of claim 15, wherein said measuring device ejector includes a body and pair of arms.

17. The power tool of claim 16, wherein a pair of retention arms are in a chamber for locking said measuring device in said chamber.

18. The power tool of claim 16, wherein said ejector arms are positioned to enhance locking of said measuring device in said chamber when said ejector is in a first position and said ejector arms are positioned to enable flexing of said ejector arms and said body contacting and forcing said measuring device out of said chamber when said ejector is in a second position.
